(19) United States
(12) Patent Application Publication
(10) Pub. No.: US 2011/0205568 A1
(43) Pub. Date: Aug. 25, 2011

(54) Imaging Device Calibration System And Method

(76) Inventors: Sasi Moalem, Holon (IL); Eyal Shelef, Tel-Aviv (IL); Shlomo Harush, Nes-Ziona (IL); Meirav Naaman, Hod HaSharon (IL)

(21) Appl. No.: 13/126,758

(22) PCT Filed: Oct. 30, 2008
(86) PCT No.: PCT/US08/81681

§ 371 Date: Apr. 28, 2011

(51) Int. Cl. H04N 1/60

(52) U.S. Cl. 358/1.9

(57) ABSTRACT

One or more imaging device calibration methods and systems are disclosed. According to one embodiment, a calibration system and method includes the application of one or more white colorants on a high optical density media prior to application of calibration targets. The system and method allow for calibration of the imaging device without the necessity for changing the substrate or stopping printing.

### BACKGROUND

Regardless of the type of color printer, color calibration is an important process for color printers and other types of devices. Color calibration maintains color consistency from specific printer to specific printer, from print job to print job, from one day to the next, and so on. Calibration is especially important when maintaining critical colors, such as colors in company logos, production of multiple prints in a single print job, production of various jobs, and so on. Modern color printers can produce excellent color output, but colors tend to drift over time, causing non-consistency and other problems for users. Many factors, such as differences between consumables and variation in environmental parameters such as temperature and humidity, effect color accuracy and consistency in printing devices. For this reason, color calibration should be done periodically.

In order to perform a color calibration, it is necessary to use a color measuring device, such as a densitometer or spectrometer. These instruments measure the degree of darkness (the optical density) of a photographic or semitransparent material or of a reflecting surface, i.e., the reflection in angles which differs from the angle of incidence. For example, the instrument illuminates at angle of 45 and measures at angle 0 (the angle between the light beam and the normal to the surface). The optical density is the logarithm of the ratio between the measured intensity Rₘ, at a specific wavelength, and the illumination intensity Rᵢₙ as follows:

OD_{A}=−Log(Rₘ/Rᵢₙ)

The optical density is a good measure of colorant layer thickness if one neglects the influence of media. Optical density of the colorant can be highly affected by the optical density of the media.

Existing color calibration methods, however, are not available for and do not address the unique characteristics of high optical density media, for example, highly glossy (high specular reflection, low diffuse reflection), colored (relatively high absorption of light by media), transparent media having a dark background, metallic media and the like. Thus, there exists a need for a color calibration method for media of these types.

### DESCRIPTION OF THE DRAWING FIGURES

FIG. 1a illustrates a diagram of light reflected from a highly glossy media.

FIG. 1b illustrates a diagram of light reflected from a semi-glossy or mat media.

FIG. 2 illustrates an imaging device for calibration according to an embodiment of the invention.

FIG. 3 illustrates a flow chart of a method of calibrating an imaging device according to an embodiment of the invention.

FIGS. 4A-4B are partial side elevation views in section illustrating an exemplary media substrate processed in accordance with a method of the invention at various stages.

FIG. 5 illustrates a graph of the optical density of a black ink layer printed on a metallic substrate according to an embodiment of the invention.

### DETAILED DESCRIPTION

In the following description, for purposes of explanation, numerous specific details are set forth in order to provide a thorough understanding of one or more aspects of the disclosure herein. It may be evident, however, that one or more aspects of the disclosure herein may be practiced with a lesser degree of these specific details.

The disclosure relates to a method for color calibration of an imaging device, particularly for media having a high optical density, and a system for calibration of a color on such a media. Here and elsewhere in the specification and claims, the ranges and ratio limits may be combined.

As used herein, the term “high optical density media” is defined as any media on which, when illuminated with a focused light beam, small amount of light is received at the measuring tool due to high specular reflection or absorption, for example, metallic media, highly glossy media, transparent media having a dark background or any colored media.

Current calibration methods rely on the measurement of ink layer thickness by illumination of a target with a focused beam of light and measuring the intensity of light reflected therefrom. The ink layer thickness “I” should be proportional to the logarithm of the ratio between the measured intensity Rₘ, at a specific wavelength, and the illumination intensity Rᵢₙ as follows:

Iα−Log(Rₘ/Rₘ)
The angle of measurement is generally different than the angle of illumination to avoid measuring the reflection from the substrate surface, which does not include much color information. By separating the light into different wavelength regions, color can be measured.

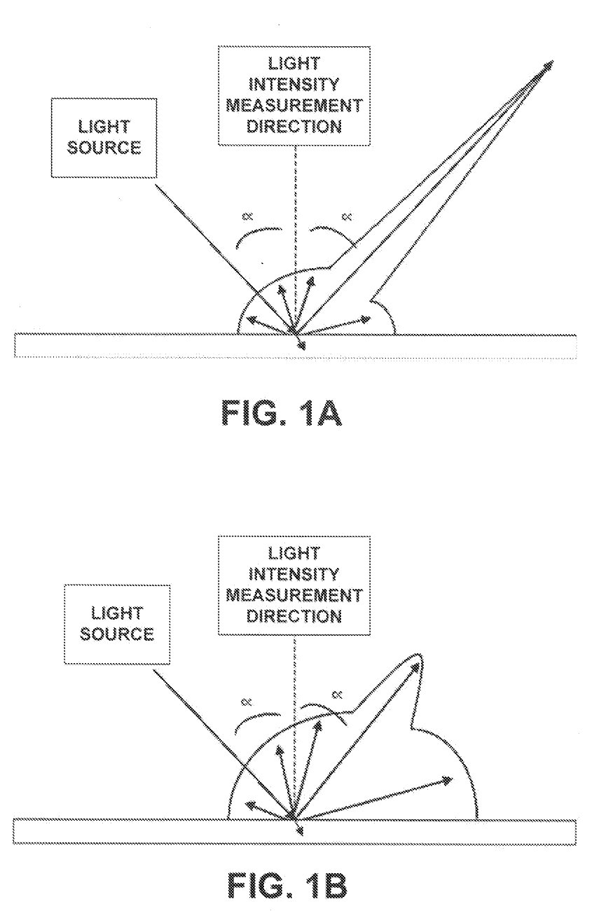

Measuring color on high optical density media, however, presents a difficulty because little to no light reaches the measuring tool, as illustrated in FIG. 1A, as opposed to the quantity of light reaching the measuring tool reflected from a semi-glossy or mat media, as illustrated in FIG. 1B.

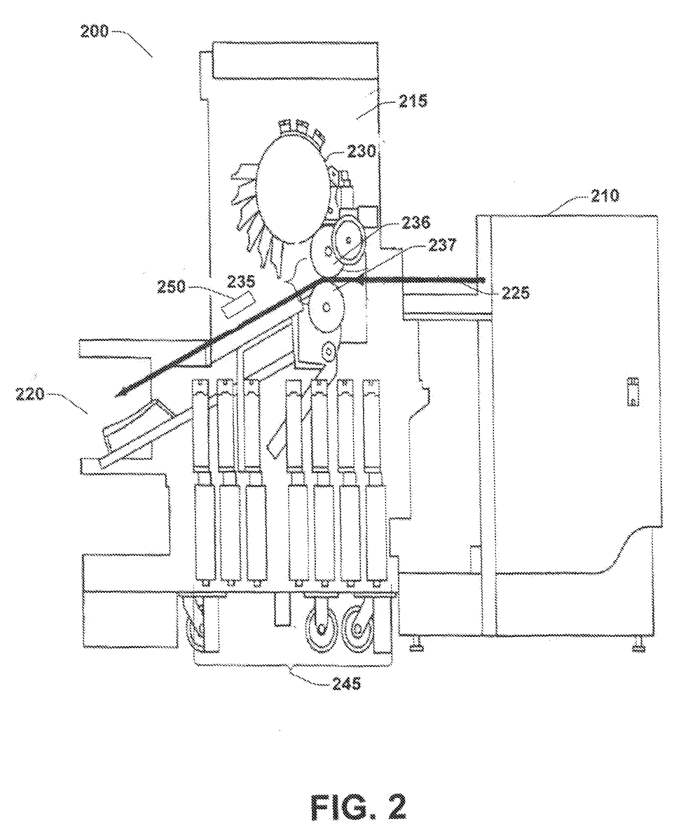

Referring to FIG. 2, there is illustrated an imaging device 200 according to an embodiment of the invention. The imaging device 200 may be arranged as a digital imaging device configured and disposed to apply color images upon high optical density media, including, for example, paper, labels, transparencies, and the like.

Imaging device 200 includes a media feed unit 210, an image engine 215 and an output handling unit 220. Media may be transferred along a media path 225 from media feed unit 210 to image engine 215 for the formation of images and subsequently output to output handling unit 220.

In the illustrated embodiment, imaging device 200 is configured to apply images to the media using a plurality of different colorants. In one embodiment, image engine 215 uses a photoconductive drum 230 to form and develop images using the colorants. The developed color images may be transferred via imaging drums 235 to media within the media path 225. The imaging drum adjacent to photoconductive drum 230 may be referred to as a blanket drum 236 while the drum adjacent to the media path 220 may be referred to as an impression drum 237.

The image engine 215 may receive the colorants from a plurality of reservoirs 245 configured to store the colorants. In one embodiment, the colorants may be liquid inks.

A sensor assembly 250 is located downstream of image engine 215 and is configured to monitor an optical characteristic or parameter of the developed target. Sensory assembly 250 is positioned along media path 220 and comprises a light emission device and light detector (not shown). In one embodiment, sensor assembly 250 is configured as a densitometer to provide information regarding optical density indicative of target thickness. Sensor assembly 250 can include one or more light emission devices, such as light emitting diodes (LEDs), configured to emit light beams of different wavelengths of light. Sensory assembly 250, may be external or internal to the imaging device 200. For example, the sensor assembly 250 may be embedded in the imaging device 200 measuring the sample substantially currently with printing of the sample by the imaging device 200. The sensor assembly 250 may also be an external tool that measures the sample after the imaging device 200 has printed it.

Sensory assembly 250 further includes light detector configured to monitor light emitted from emission devices and reflected by target generated on media. For example, light detector can be implemented as a light-to-voltage (LTV) detector, such as a photodiode, or other sensor configuration arranged to receive photons of light reflected from image and to output an electrical signal indicative of the photons received by the light detector. The electrical signal can be indicative of an optical characteristic of the target being sensed by the sensor.

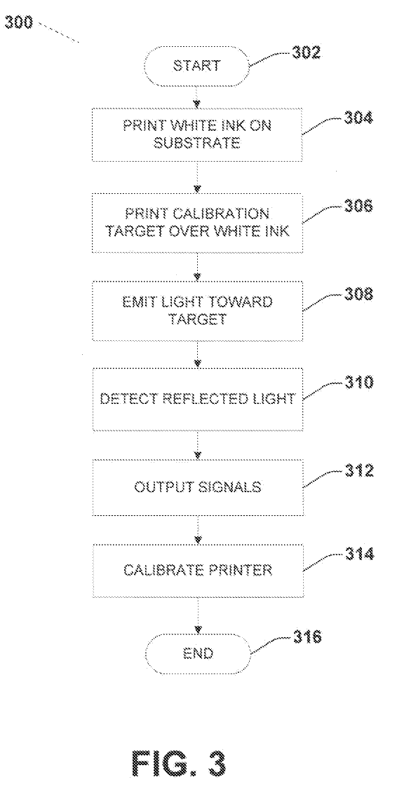

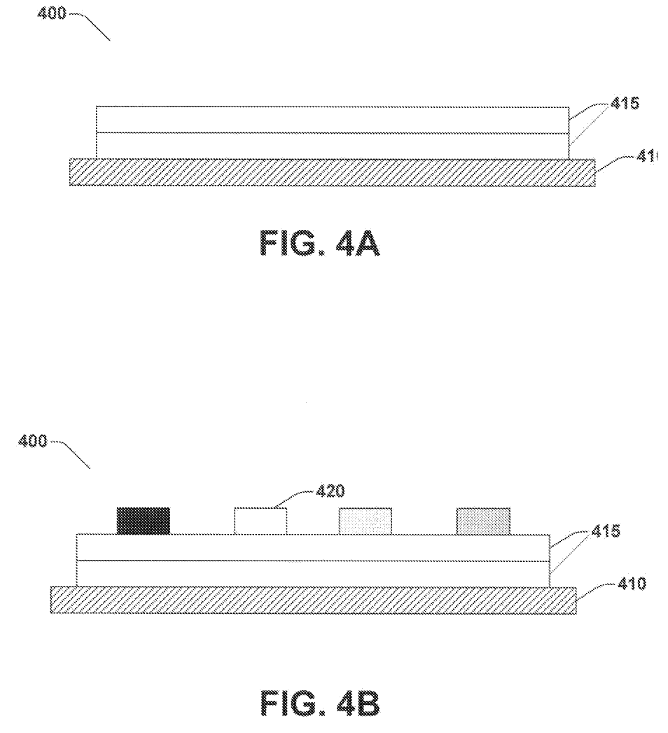

FIG. 3 illustrates an exemplary method 300 according to an embodiment of the invention for calibration of an imaging device using high optical density media. FIGS. 4A-4C illustrate an exemplary implementation of portions of the method relating application of a white colorant to the high optical density media. While the exemplary method 300 is illustrated and described below as a series of acts or events, it will be appreciated that the present invention is not limited by the illustrated ordering of such acts or events. For example, some acts may occur in different orders and/or concurrently with other acts or events apart from those illustrated and/or described herein, in accordance with the invention. In addition, not all illustrated steps may be required to implement a methodology in accordance with the present invention.

At least some parts of the method 300 may be performed by execution of a computer program by a processor of a computerized device. The computer program may be stored on a computer-readable medium, such as a removable or permanent storage medium like a floppy disk or a hard disk drive, or a volatile or non-volatile memory, such as embedded printer firmware. The functionality of each step or act of the method 300 may be preformed by corresponding and/or respective means of the computer program. The computerized device may be a computer, and the device to be color calibrated, a printer. The printer may be configured as a digital or offset printing press, but can include other printing devices, as will be known to those skilled in the art.

Method 300 begins at 302 by application of a white colorant onto a high optical density media substrate 304 by an imaging device to be color calibrated or otherwise generated by a device to be color calibrated. In one embodiment, at least one layer of the colorant is applied to the media at a specific area. In another embodiment, a plurality of layers of white colorant is applied, for example, from about one to about five layers. Not wishing to be bound by theory, it is thought that the addition of the white colorant layers provides for diffusion of the light by making the surface less smooth and/or reduces the absorption of light by media for several wavelengths, and reduces the variance of spectrum reflection between different substrates, thereby increasing the amount of light reaching the sensor assembly for measurement of an optical characteristic.

One or more calibration targets are applied over the white colorant at 306. After printing the calibration target 306, light is emitted toward the target at 308 by, for example, a sensor assembly. Light reflected from the target is detected at 310. An electrical signal indicative of an optical characteristic, for example, optical density, is output at 312 and read with a device that generates optical density or other types of values which are entered into a calibration module to determine the adjustment necessary to provide for consistent colors and calibration of the imaging device at 314.

One or more corrective actions are then performed relative to the measured values to render the color values more accurate. Color calibration is performed for the device based on the values as measured and on which corrective action has been performed. The color calibration compares the measured values with the ideal or desired values. One or more color conversion tables are generated that map the former to the latter, so that subsequent output on the device yields the desired color as the actual color. These tables may be output for subsequent use by the device being calibrated. Following calibration of the imaging device, the method ends at 316.

Referring now to FIGS. 3 and 4A-4C, there is illustrated an exemplary media substrate 400 at various stages or processing generally according to the method 300. In this example, the media substrate 410 is illustrated in further detail in FIG. 4A, where one or more layers 415 of a white colorant are applied to the substrate 410 (e.g., 104 in method 300 of FIG. 3).

The colorant may comprise an ink. The ink may be dye or pigment-based. The colorant is applied to the media at a specific area as a long strip, for example, about 8 cm×40 cm. However, it will be understood that application of the colorant to the media can occur in any configuration which fits the measuring device specifications. Regardless of the configuration of the colorant on the media, the colorant may be applied to the media at a thickness, in one embodiment of from about 1 micron up to about 5 microns.

Following application of the white colorant layers 415 to the substrate, one or more calibration targets 420 are applied over the white colorant layers 415 (106 in method 300 of FIG. 3). The color calibration target serves as the basis on which color calibration of the printer is to be performed. Generally, the color calibration target is generated according to a given color type according to which color calibration is to be performed. For instance, the color type may be CMY, where the sample is printed by a printer having cyan, magenta, and yellow ink colors. Other color types include RGB, for red, green, and blue colors, and HSB, for hue, saturation, and brightness, among others. Two other color types, CIEXYZ and CIELAB, are defined by the Commission Internationale de I'Eclairage. For linearization color calibration, the color calibration target may have a number of different colors that range from 0 to 100% ink coverage for each ink color that a given printer or other device uses. Other types of color calibration are also amenable to the invention, however.

The following examples illustrate calibration operations of an imaging device according to the method of the invention. The following examples should not be considered as limitations of the disclosure herein, but are merely provided to based upon current experimental data.

### EXAMPLE 1

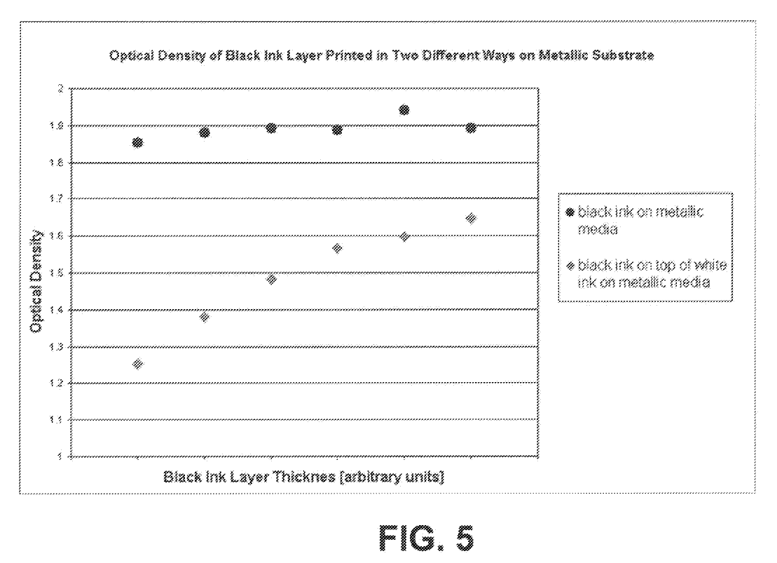

A black ink layer having a thickness of about 5 micron was printed on a high optical density substrate using a HP Indigo WS4500 press. On the same substrate, a strip of a white ink layer having a thickness of about 10 micron was printed. Optical density measurements of the white and black ink layers were then performed using a X-Rite DTP24 densitometer. Results of the measurements are shown in FIG. 5. As can be seen from FIG. 5, it is clear that the range for the calibration of the black ink layer thickness widens when having a white layer printed beneath, according to the invention.

Although the disclosure has been shown and described with respect to one or more embodiments and/or implementations, equivalent alterations and/or modifications will occur to others skilled in the art based upon a reading and understanding of this specification. The disclosure is intended to include all such modifications and alterations and is limited only by the scope of the following claims. In addition, while a particular feature may have been disclosed with respect to only one of several embodiments and/or implementations, such feature may be combined with one or more other features of the other embodiments and/or implementations as may be desired and/or advantageous for any given or particular application. Furthermore, to the extent that the terms “includes”, “having”, “has”, “with”, or variants thereof are used in either the detailed description or the claims, such terms are intended to be inclusive in a manner similar to the term “comprising.”

What is claimed is:

1. A method for the color calibration of an imaging device comprising:
providing a high optical density media;
applying at least one layer of a white colorant to the high optical density media;
forming one or more calibration targets overlying the white colorant; and
performing a color calibration of the imaging device.

2. The method of claim 1, wherein the high optical density media comprises one or more of a metallic media, a highly glossy media, or a transparent media.

3. The method of claim 1, wherein the white colorant comprises an ink.

4. The method of claim 3, the colorant applied at a thickness of from about 1 micron up to about 5 microns.

5. The method of claim 1, the performing comprising:
measuring numeric values that correlate to ink film thickness;
comparing the measured values with ideal or desired values; and
generating a color conversion table to map the measured values to the desired values.

6. The method of claim 5, the measuring performed by one or more of a densitometer, a spectrophotometer, or colorimeter.

7. The method of claim 1, the imaging device comprising a web press.

8. A system for calibration of a colorant on a high optical density media comprising:
an imaging device configured and arranged for application of a white colorant on the high optical density media, followed by generation of calibration targets overlying the white colorant; and
a sensor assembly comprising a light emission device and a light detector.

9. The system of claim 8, the imaging device configured to apply one or more layers of the white colorant on the media.

10. The system of claim 8, the light emission device configured to emit light beams of different wavelengths of light.

11. The system of claim 8, the light detector configured to monitor light emitted from emission devices and reflected by targets generated on media.

12. The system of claim 11, the light detector comprising a light-to-voltage (LTV) detector.

13. The system of claim 12, the light detector further configured to output an electrical signal indicative of photons received by the light detector.

14. The system of claim 13, the electrical signal indicative of an optical characteristic of the target being sensed by the sensor.

15. The system of claim 8, the high optical density media comprising one or more of a metallic media, a highly glossy media, or a transparent media.
